(19) United States
(12) Patent Application Publication
(10) Pub. No.: US 2015/0341238 A1
(43) Pub. Date: Nov. 26, 2015

(54) IDENTIFYING SLOW DRAINING DEVICES IN A STORAGE AREA NETWORK

(71) Applicant: Virtual Instruments Corporation, San Jose, CA (US)

(72) Inventors: Ana Bertran Ortiz, San Francisco, CA (US); Nicholas York, San Ramon, CA (US); Genti Cuni, Mountain View, CA (US)

(73) Assignee: Virtual Instruments Corporation, San Jose, CA (US)

(21) Appl. No.: 14/284,001

(22) Filed: May 21, 2014

(51) Int. Cl. H04L 12/26; H04L 29/08

(52) U.S. Cl. CPC H04L 43/08; H04L 43/026; H04L 67/1097

(57) ABSTRACT

A link in a storage area network (SAN) is identified that is being affected by one or more slow draining devices. Devices in the SAN are identified as candidates for potentially being a slow draining device affecting the link. For each identified candidate device, metric data is identified that describes, for example, traffic activity of the candidate device, such as data transmission rates of the candidate device. Additionally, metric data is identified for the link. For each candidate device, a correlation value is determined that indicates the likelihood that the candidate device is a slow draining device affecting the link. The correlation value of a candidate device is determined based on the correlation between the metric data of the device and the metric data of the link. One or more of the correlation values are presented to a user via a user interface.

### CROSS-REFERENCE TO RELATED APPLICATION

This application is related to U.S. application Ser. No. ______ filed on ______, titled “Identifying Problems in a Storage Area Network” (atty dkt no. 28466-24751), the contents of which is hereby incorporated by reference.

### BACKGROUND

1. Technical Field

The described embodiments pertain in general to data networks, and in particular to identifying slow draining devices in a storage area network.

2. Description of the Related Art

A storage area network (SAN) is a data network through which servers communicate with storage devices for storing and retrieving block level data. A SAN typically includes multiple servers and storage devices connected via multiple fabrics, where each fabric includes multiple switches. In a SAN, prior to a device (transmitting device) transmitting data to another device (receiving device), the receiving device assigns a certain number of its buffer slots to the transmitting device. The assigned number of buffer slots is referred to as buffer-to-buffer credits.

Each time the transmitting device transmits a data frame to the receiving device, the buffer-to-buffer credits are decremented by one. When the receiving device processes the data frame it sends a Receiver Ready message to the transmitting device and the transmitting device increments the credits by one.

The transmitting device can continue transmitting frames to the receiving device, even without receiving a Receiver Ready message, as long as it has credits remaining But if at any point the transmitting device runs out of buffer-to-buffer credits, the transmitting device must stop the transmission of data in order to not overflow the receiving device's buffer, where the stoppage causes congestion in the SAN. Therefore, the transmitting device will reach zero buffer credits as a result of the receiving device being delayed in processing frames and returning Receiver Ready messages. The root cause of the receiving device being delayed in processing frames could be the receiving device itself or another device in the SAN.

As an example, assume a server is connected to a storage device via a switch. Further assume that the server requests a file from the storage device. The file is identified by the storage device and is ready for transmission to the server via the switch. The switch assigns a certain number of buffer-to-buffer credits to the storage device so that the storage device can transmit the file's data frames to the switch. Similarly the server assigns buffer-to-buffer credits to the switch since it will be transmitting the file's frames to the server. If the storage device runs out buffer-to-buffer credits to transmit data frames, the root cause could be that switch is malfunctioning causing it to slowly process data frames received from the storage device. Another root cause could be that the server is slow in processing received data frames, thereby delaying the switch and causing the storage device to run out of credits.

The device that is the root cause of one or more devices in a SAN running out of buffer-to-buffer credits is referred to as a slow draining device. Since a SAN includes hundreds of devices, identifying a slow draining device in a SAN is a difficult task.

### SUMMARY

The described embodiments provide methods, computer program products, and systems for identifying slow draining devices in a storage area network (SAN). A link in the SAN is identified that is being affected by one or more slow draining devices causing a slowdown in traffic along the link. Devices in the SAN are identified as candidates for potentially being a slow draining device affecting the link.

For each identified candidate device, metric data is identified that describes, for example, traffic activity of the candidate device, such as data transmission rates of the candidate device. Additionally, metric data is identified for the link, such as values of the percentage of time the link spent with zero buffer-to-buffer credits.

For each candidate device, a correlation value is determined that indicates the likelihood that the candidate device is a slow draining device affecting the link. The correlation value of a candidate device is determined based on the maximum of a cross-correlation function between the metric data of the device and the metric data of the link. One or more of the correlation values are presented to a user via a user interface.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of a monitored storage area network (SAN) according to one embodiment.

FIG. 2 is a block diagram illustrating an example of a network of switch fabrics according to one embodiment.

FIG. 3 is a block diagram illustrating modules within an information system according to one embodiment.

FIG. 4 is a flow diagram of a process for providing information regarding potential slow draining devices affecting a link in a SAN according to one embodiment.

FIG. 5 is a block diagram illustrating components of an example machine according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

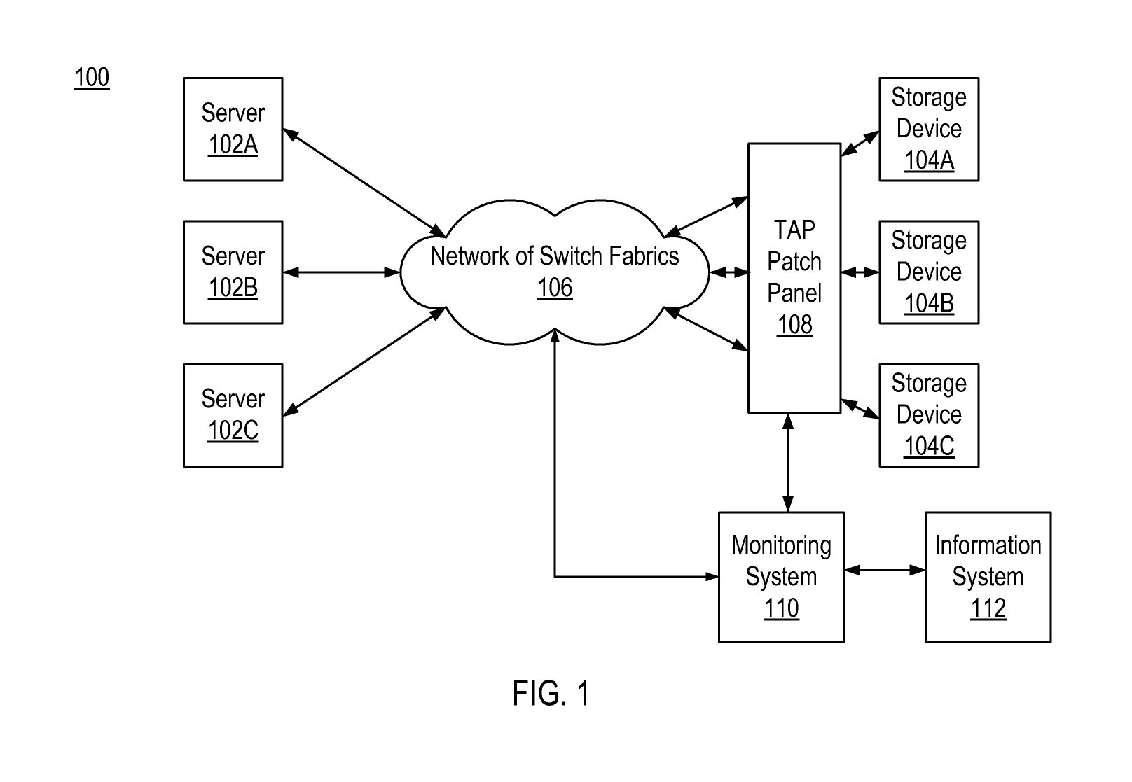

FIG. 1 is a block diagram of a monitored storage area network (SAN) 100 according to one embodiment. The SAN 100 includes three servers 102A, 102B, and 102C and three storage devices 104A, 104B, and 104C. The servers 102 and the storage devices 104 are connected via a network of switch fabrics 106. Although the illustrated SAN 100 only includes three servers 102 and three storage devices 104, other embodiments can include more of each entity.

The figures described herein use like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral (e.g. “102” in the text refers to reference numerals “102A,” “102B,” and/or “102C” in the figures).

A server 102 is a computing system that has access to the storage capabilities of the storage devices 104. A server 102 may provide data to a storage device 104 for storage and may retrieve stored data from a storage device 104. Therefore, a server 102 acts as a source device when providing data to a storage device 104 and acts as a destination device when requesting stored data from a storage device 104.

A storage device 104 is a storage system that stores data. In one embodiment, a storage device 104 is a disk array. In other embodiments, a storage device 104 is a tape library or an optical jukebox. When a storage device 104 receives a request from a server 102 to store data, the storage device 104 stores the data according to the request. When a storage device 104 receives a request from a server 102 for stored data, the storage device 104 retrieves the requested data and transmits it to the server 102.

The servers 102 and the storage devices 104 communicate and exchange data via the network of switch fabrics 106. The network of switch fabrics 106 includes one or more fiber channel switch fabrics. Each fabric of the network 106 includes one or more fiber channel switches that route data between devices. Several communication channels exist between the devices (e.g., servers 102, storage devices 104 and switches) included in the SAN 100. The communication channels are mediums through which signals are transported between devices. Communication channels are also referred to as “links” herein.

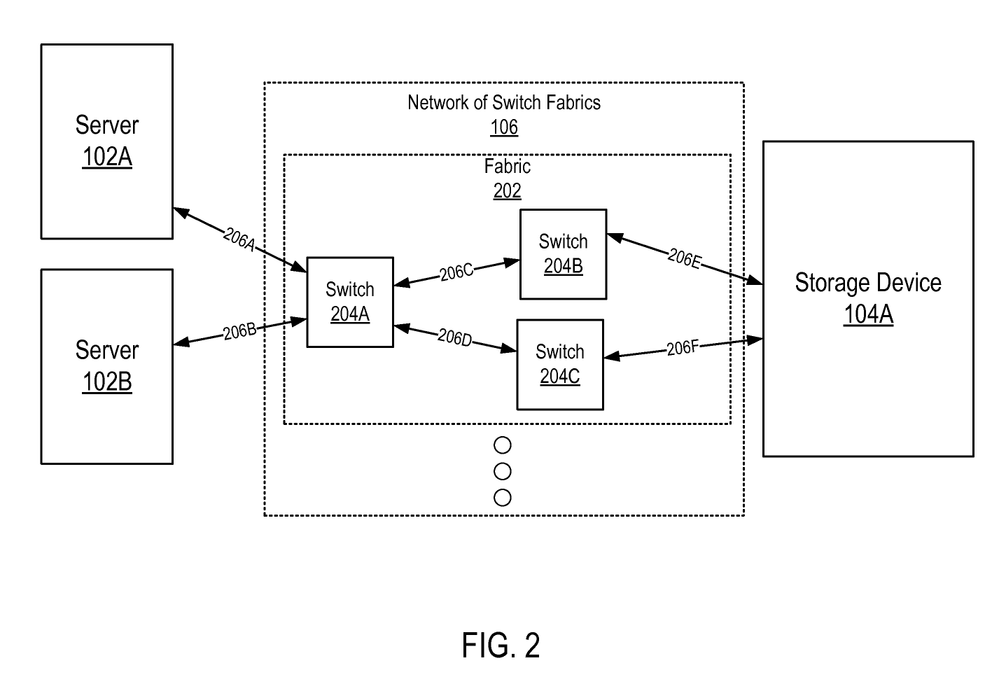

FIG. 2 illustrates an example of a fabric 202 of the network 106 and links between servers 102A and 102B and storage device 104A. The example of FIG. 2 illustrates a single fabric from multiple fabrics of the network of switch fabrics 106. For example, in addition to fabric 202, the network 106 may include a redundant fabric. Fabric 202 includes switches 204A, 204B, and 204C. As can be seen in FIG. 2, several links 206A-206F connect servers 102A and 102B to the storage device 104A through switches 204A, 204B, and 204C.

Returning to FIG. 1, the monitored SAN 100 also includes a traffic access point (TAP) patch panel 108, a monitoring system 110, and an information system 112. The TAP patch panel 108 is a hardware device inserted between the server 102 and the storage device 104. The TAP patch panel 108 diverts at least a portion of the signals being transmitted along certain links to the monitoring system 110. In one embodiment, the links for which signals are diverted are selected by a system administrator.

In one embodiment, the links in the SAN 100 are optical fibers and the network communications traveling on the optical fibers are provided via optical signals. The optical signals are converted to electrical signals at various devices (e.g., a server 102, a storage device 104, and the monitoring system 110). According to this embodiment, the TAP patch panel 108 operates by diverting for certain links a portion of light traveling on a link to an optical fiber connected to the monitoring system 110.

The monitoring system 110 is a computing system that collects metric data associated with entities in the SAN 100. In one embodiment, the monitoring system 110 is the VirtualWisdom SAN Performance Probe provided by Virtual Instruments Corporation of San Jose, Calif. The entities for which the monitoring system 110 collects metric data may be any device or component in the SAN 100, such as links, servers 102, storage devices 104, switches, ports of devices, etc.

In one embodiment, software probes run on the monitoring system 110 and utilize standard protocols to poll devices in the SAN (e.g., servers 102, storage devices 104, and switches) for available configuration and metric data of the devices, such as data that describes network traffic (referred to as “traffic data” herein), event counters, CPU and memory usage.

Additionally, the monitoring system 110 analyzes the signals received from the TAP patch panel 108. Based on the analyzed signals, the monitoring system 110 collects (e.g., measure and/or calculates) metric data for links in the SAN 100, including traffic data that describes network traffic on the links. The links for which the monitoring system 110 collects metric data are referred to as “monitored links” herein.

An example of metric data that may be collected by the monitoring system 110 for a monitored link is a percentage of time that a device directly connected to the link spent with zero buffer-to-buffer credits. As described above in the background section, buffer-to-buffer credits are a number of buffer slots assigned by a receiving device in the SAN 100 to a transmitting device transmitting data to the receiving device. Each time the transmitting device transmits a data frame to the receiving device, the credits are decremented by one. When the receiving device processes the data frame it sends a Receiver Ready message to the transmitting device and the transmitting device increments the credits by one.

A transmitting device can continue to transmit data frames to a receiving device, even without receiving a Receiver Ready message, as long as it has credits remaining. However, if the transmitting device reaches zero buffer-to-buffer credits, the transmitting device has to stop the transmission of data to the receiving device until it receives additional credits. A device in the SAN that is a root cause of a transmitting device spending time at zero buffer-to-buffer credits is referred to as a “slow draining device.” The cause of a device in the SAN 100 becoming a slow draining device, may be for example, that there is a mismatch between the speed at which a transmitting device is transmitting data and the speed at which a receiving device is receiving/processing the data (e.g., a 2 GB server 102 receiving requested data from a 8 GB storage device 104). Other causes of a device becoming a slow draining device include, the CPU of the device being overly utilized by multiple processes, the device having limited bandwidth and the device having failing hardware.

Examples of additional metric data that may be collected by the monitoring system 110 for a monitored link include: data transmission rate through the link (e.g., the average number of bits transmitted along the link per a unit time, such as megabits per second), read exchange completion time (average amount of time it takes for a read command along the link to be processed), write exchange completion time (average amount of time it takes for a write command along the link to be processed), and average input output operations per second.

In one embodiment, the monitoring system 110 associates a time with collected metric data of an entity. The time indicates when the conditions described by the metric data existed. For example, for a monitored link if the metric data is “Y megabits per second on average” and a time X is associated with the data, it signifies that at time X the average data transmission rate through the link was Y megabits per second. In one embodiment, the frequency with which the monitoring system 110 collects metric data for entities is set by a system administrator.

On a periodic basis the monitoring system 110 transmits the collected metric data to the information system 112. In one embodiment, the metric data is transmitted to the information system 112 via a local area network.

The information system 112 is a computing system that provides users with information regarding the health of the SAN 100. Upon request from a user or at a preset time, the information system 112 analyzes metric data received from the monitoring system 110 for the monitored links and determines whether at least one link in the SAN 100 is being affected by a slow draining device. Specifically, the information system 112 determines whether a device directly connected to a link has spent time with zero buffer-to-buffer credits resulting in a slowdown in traffic along the link. If a link affected by a slow draining device is identified, the information system 112 identifies devices in the SAN 100 that are candidates for potentially being slow draining devices affecting the link. The information system 112 identifies metric data of the candidate devices over one or more periods of time. The information system 112 additionally identifies metric data of the link over the same periods of time that indicates the percentage of time that the device directly connected to the link spent with zero buffer-to-buffer credits.

For each of the candidate devices, the information system 112 determines a correlation value indicative of the likelihood that the candidate device is a slow draining device affecting the link. The information system 112 determines the correlation value of a candidate device based on the maximum of a cross-correlation function between the candidate device's metric data and the identified metric data of the link.

The information system 112 transmits information to display a user interface to a user (e.g., a system administrator) that includes an indication as to which candidate devices are likely to be a slow draining device affecting the SAN. In one embodiment, the interface includes identifiers of the candidate devices and their respective correlation values. In one embodiment, the interface only includes identifiers of a certain number of candidate devices for which the highest correlation values were determined (e.g., include candidate devices with top 5 correlation values). The user can use the information presented in the interface to investigate the performance of the identified devices and determine whether there are any problems with the devices (e.g., devices malfunctioning or being over utilized). In another embodiment, the interface also includes configuration information for the device, for example, its configured link speed.

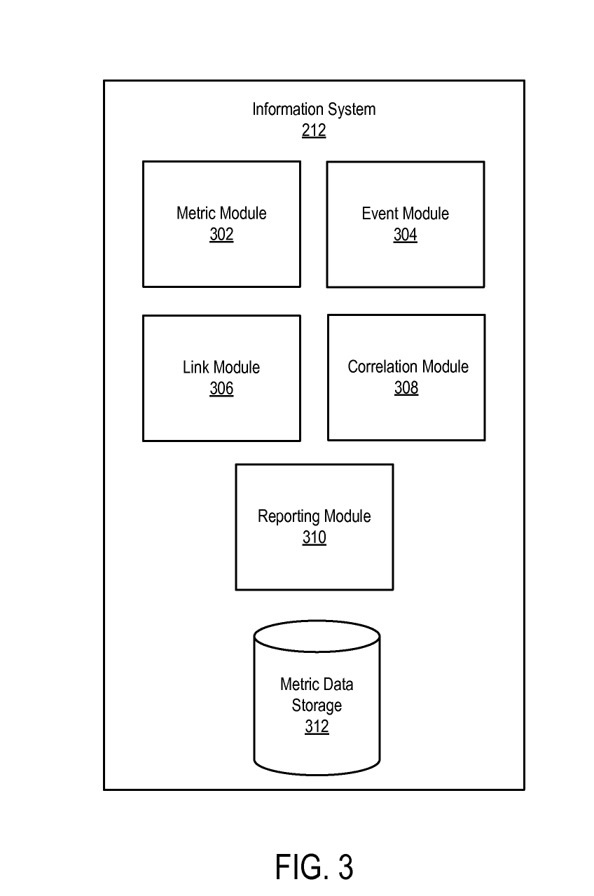

FIG. 3 is a block diagram illustrating modules within the information system 112 according to one embodiment. The information system 112 includes a metric module 302, an event module 304, a link module 306, a correlation module 308, a reporting module 310 and a metric data storage 312. Those of skill in the art will recognize that other embodiments can have different and/or other modules than the ones described here, and that the functionalities can be distributed among the modules in a different manner.

The metric module 302 processes metric data received from the monitoring system 110. In one embodiment, when metric data of an entity (associated with an entity) is received from the monitoring system 110, the metric module 302 stores the data in the metric data storage 312. Based on the storing of the data received from the monitoring system 110, for each monitored entity the metric data storage 312 includes various data points at various times. For example, for each monitored link, the metric data storage 312 may include for every hour the data transfer rate of the link and the percentage of time during the hour that a device connected to the link spent with zero buffer-to-buffer credits.

The event module 304 initiates a process of identifying potential slow draining devices in the SAN 100. In one embodiment, the process is initiated when a request is received from a user (e.g., a system administrator) to perform the process. In one embodiment, the process is initiated periodically (e.g., once a week). The process specifically involves analyzing metric data of monitored links for slow draining events, identifying links severely affected by one or more slow draining devices, and identifying potential slow draining devices affecting the identified links.

As part of the process, for each monitored link, the event module 304 retrieves, from the metric data storage 312, metric data associated with times that are within a certain time period. Specifically, the metric data retrieved for a monitored link are values of the percentage of time the link spent with zero buffer-to-buffer credits (percentage of time a device directly connected to a link has spent with zero credits), where the values are associated with times within the certain time period (e.g., within the past 36 hours). Therefore, based on the data retrieved from the metric data storage 312, a data series is identified for each monitored link that includes multiple data points. Each data point in a monitored link's data series is a zero buffer-to-buffer credits percentage value. The time period used for retrieving the metric data may be indicated by a user initiating the process or may be preset.

For each monitored link, the event module 304 groups data points of the link's data series that satisfy certain criteria. In one embodiment, the event module 304 groups data points that are above a percentage threshold (above threshold data points) where no above threshold data point is separated from another above threshold data point in the series by more than a set number of consecutive below threshold data points (data points below the threshold). Each created group of data points is an identified slow draining event. A slow draining event is a signature indicative of a link being affected by one or more slow draining devices, which causes a slowdown in network traffic along the link.

In one embodiment, to group data points/identify slow draining events, the event module 304 starts at the beginning of the data series and identifies the first data point above the percentage threshold. The event module 304 then continues through the data series until it identifies a set number of consecutive data points in the series that are below the percentage threshold (e.g., three consecutive below threshold data points). The event module 304 includes in a first group/slow draining event, the first data point identified above the threshold and the data point (referred to as the “last group data point”) in the series immediately prior to the first of the consecutive below threshold data points. The event module 304 also includes in the first group any data points between the first data point and the last group data point in the series. The event module 304 continues through the data series and repeats the process to potentially create additional groups. In one embodiment, the percentage threshold and the set number of consecutive data points used for separating groups is preset by a system administrator.

As an example of identifying slow draining events, assume the data series includes the following data point values: 3, 2, 15, 20, 2, 11, 5, 4, 6, 12, 13, 2, 3, 5. Further assume that the percentage threshold is 7 and that in a group an above threshold data point cannot be separated from another above threshold data point by more than 2 data points in the series. In this example, two slow draining events are identified. The first slow draining event includes data points 15, 20, 2, and 11. The first slow draining event starts with 15 because it is the first data point in the series above the threshold. The first slow draining event ends after 11 because the 5, 4, 6 values after the 11 are three consecutive data points below the threshold. The second slow draining event includes data points 12 and 13. The second slow draining event starts with 12 because it is the first data point above the threshold after the first event. The second slow draining event ends after the 13 because 2, 3, and 5 are each below the threshold.

The link module 306 identifies monitored links severely affected by a slow draining device. For each monitored link for which one or more slow draining events were identified by the event module 304, the link module 306 determines an aggregated event score for the link. The aggregated event score of a link is determined based on the one or more slow draining events identified for the link. The aggregated event score of a link is a measure indicative of the degree to which one or more slow draining devices are affecting the link.

To determine the aggregated event score of a link, the scoring module 306 calculates a weighted score for each slow draining event identified by the event module 304 for the link. To calculate the weighted score of a slow draining event, the scoring module 306 identifies the data points of the event (i.e., the grouped data points). The scoring module 306 multiplies the value of each data point by a weighted value and sums the multiplied data points. The result of the summation is the weighted score of the event. In one embodiment, each data point is multiplied by the same weighted value. In another embodiment, the weighted value used for each data point value varies depending on the data point's value. For example, assume if the data point value is below 20%, the data point value is not taken into account in calculating the weighted score of the event. In other words, the data point value is multiplied by a weight value of zero. On the other hand, if the data point value is 20% or greater, the value gets weighed by a weight value that varies linearly from 1 at 20% to 10 at 100%. In other words, if the data point value is 20% or greater, the data point gets multiplied by a weight value equal to 1+0.1125(X−20), where X is the data point value. Therefore, in this example if the event's data points have values of 8, 40, and 20, the weighted score of the event would be equal to: (40×3.25)+(20×1).

The link module 306 determines the aggregated event score of the link based on the weighted scores of the link's slow draining events. In one embodiment, the scoring module 306 determines the aggregated event score to be the sum of the events' weighted scores. In another embodiment, the scoring module 306 determines the aggregated event score to be equal to highest weighted score determined for the events.

Based on the calculated aggregated event scores, the link module 306 selects links for which the correlation module 308 will determine potential slow draining devices affecting the links. The links selected by the link module 306 are those that are most severely being affected by one or more slow draining devices. In one embodiment, the link module 306 selects a certain number of links that have the highest aggregated event scores (e.g., selects links with the 5 highest aggregated event scores). In another embodiment, the link module 306 selects links with an aggregated event score that is above a score threshold. In another embodiment, the link module 306 selects each link for which at least one slow draining event was identified.

For each link selected by the link module 306, the correlation module 308 identifies a data template to use for identifying potential slow draining devices affecting the link. The data template includes metric data of the link. In one embodiment, the data template includes the data of each slow draining event identified by the event module 304 for the link. In another embodiment, the data template includes the data of certain slow draining events identified for the link. For example, the template may include the data of a certain number of slow draining events of the link with the highest weighted scores calculated by the link module 306. In another embodiment, the data template includes the entire data series analyzed by the event module 304 to identify slow draining events of the link.

The correlation module 308 additionally identifies devices in the SAN 100 as candidates for potentially being slow draining devices affecting the link (referred to as “candidate devices”). In one embodiment, correlation module 308 identifies each server 102 as a candidate device. Servers 102 are identified as candidate devices because it possible that a server 102 is operating at a lower speed than the storage devices 104 (e.g., due to hardware restrictions), has failing hardware, or is being overly utilized, thereby causing the device 102 to function as a slow draining device in the SAN 100. Other devices that may be identified as candidate devices by the correlation module 308 include switches 204 (e.g., switches 204 from which the monitoring system 110 collects metric data) and storage devices 104.

For each candidate device, the correlation module 308 retrieves metric data from the metric data storage 312. The metric data retrieved for a candidate device describes characteristics of the device (network/traffic activity of the device) during certain times. Specifically, the metric data describes characteristics of the candidate device during times for which the data template includes metric data of the link. For example, if the data template includes metric data of the link between time X and time Y, the retrieved metric data for a candidate device describes characteristics of the device between time X and time Y. In one embodiment, the type of metric data retrieved for each candidate device is the data transmission rate of the device. Other types of metric data that may be retrieved for each candidate device include read exchange completion times, write exchange completion times, utilization and average input output operations per second.

For the metric data retrieved for each candidate device, the correlation module 308 compares the metric data to the data template. In one embodiment, multiple data templates are identified for the link. Each data template has a different resolution. The correlation module 308 selects to compare the metric data of the candidate device with a data template having the same resolution as the candidate device's metric data. Based on the comparison, the correlation module 308 determines whether a data point is included in the metric data at each time at which a data point is included in the data template. If the data template includes a data point at a specific time but no data point is included in the retrieved metric data at that time, the correlation module 308 performs an interpolation to add a data point to the retrieved metric data at the specific time.

Additionally, for the metric data retrieved for each candidate device, the correlation module 308 normalizes the data points included in the retrieved metric data. The correlation module 308 also normalizes the data points included in the data template of the link. Normalizing a set of data points includes, for example, subtracting from each data point the mean of the set of data points and dividing the result of the subtraction by the standard deviation of the set of data points.

The correlation module 308 determines a correlation value for each candidate device. The correlation value of a candidate device is determined by the correlation module 308 based on the correlation between the normalized metric data of the candidate device and the normalized data template of the link. The higher the correlation value, the higher the correlation between the metric data and the data template. Additionally, the higher the correlation value, the more likely the candidate device is a slow draining device affecting the link.

In one embodiment, to determine the correlation value of a candidate device, the correlation module 308 calculates the cross-correlation function between the data series of the template and the data series of the candidate device. The cross-correlation function calculates the correlation at different time lags between the two data series. The correlation value for the candidate device is then taken to be the maximum value of the cross-correlation function.

The reporting module 310 notifies users of potential slow draining devices in the SAN 100. In one embodiment, when the information system 112 receives a request from a user device (e.g., device of a system administrator) for information regarding slow draining devices affecting the SAN 100, the reporting module 310 transmits instructions to the user device to display a user interface. In one embodiment, the user interface includes an identifier of each link identified by the link module 306 as being affected by a slow draining device and for which potential slow draining devices were identified by correlation module 308. With each of the links, the user interface includes identifiers of one or more devices in the SAN 100 that are potentially slow draining devices affecting the link. In one embodiment, the reporting module 310 includes a certain number of devices with the highest correlation values determined by the correlation module 308 for the link (e.g., three candidate devices with the highest correlation values). In one embodiment, the reporting module 310 includes a device only if its correlation value is higher than a set correlation threshold. With the identifier of each device, the interface includes the correlation value determined by the correlation module 308 for the device.

In one embodiment, through the user interface the user can request to view the devices in the SAN 100 for which the highest correlation values were determined out of all the links. When such a request is made, the reporting module 310 identifies in the metric data storage 312 the highest correlation values determined (e.g., top 10 correlation values). The reporting module 310 includes each identified correlation value along with an identifier of the device for which the value was determined.

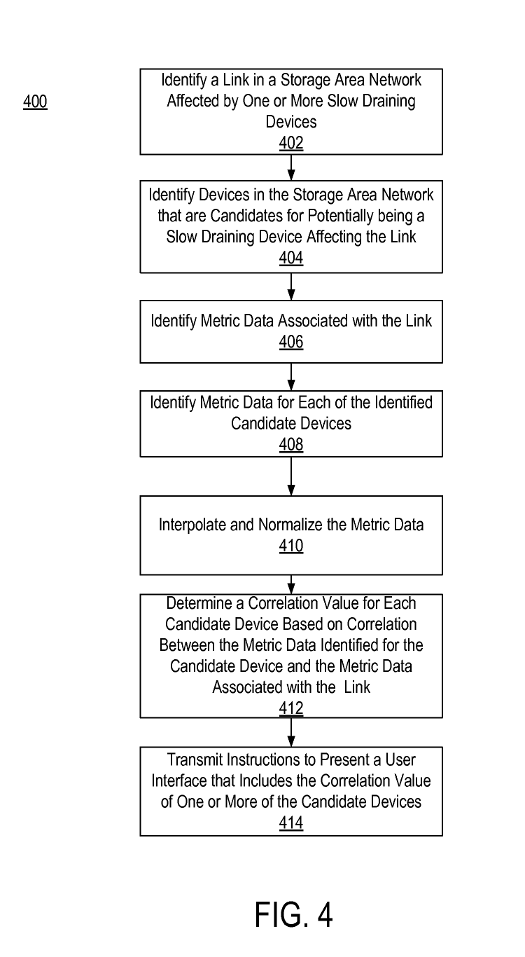

FIG. 4 is a flow diagram of a process 400 performed by the information system 112 for providing information regarding potential slow draining devices affecting a link in the SAN 100 according to one embodiment. Those of skill in the art will recognize that other embodiments can perform the steps of FIG. 4 in different orders. Moreover, other embodiments can include different and/or additional steps than the ones described herein.

The information system 112 identifies 402 a link in the SAN 100 affected by one or more slow draining devices. In one embodiment, one or more slow draining events are identified from metric data associated with the link. The information system 112 identifies 404 devices in the SAN that are candidates for potentially being a slow draining device affecting the link.

The information system 112 identifies 406 metric data (a data template) associated with the link. In one embodiment, the identified metric data includes the data of one or more slow draining events identified for the link. The information system 112 also identifies 408 metric data for each identified candidate device. The metric data of each candidate device describes characteristics of the device during one or more time periods that correspond to metric data of the link.

The information system 112 interpolates 410 and normalizes the metric data identified for the candidate devices. Additionally, the information system 112 normalizes the metric data associated with the link. For each candidate device, the information system 112 determines 412 a correlation value based on the maximum of the cross-correlation function between the metric data identified for the candidate device and the metric data associated with the link. The information system 112 transmits 414 instructions to present a user interface that includes the correlation values of one or more of the candidate devices along with identifiers of the one or more candidate devices. In one embodiment, the user interface includes a certain number of the highest calculated correlations values.

Although the processes of determining potential slow draining devices affecting links has been described in a storage area network environment, it should be understood that the processes can be applied to other network environments.

### Computing Machine Architecture

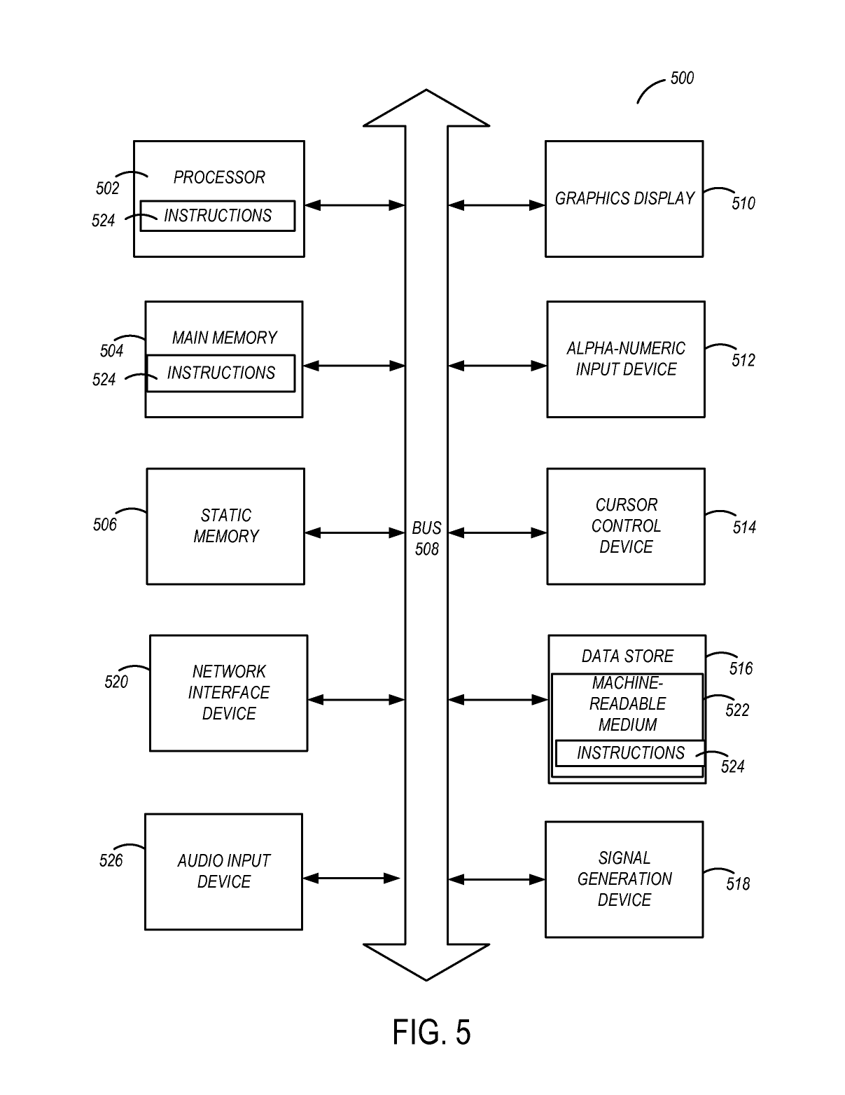

FIG. 5 is a block diagram illustrating components of an example machine able to read instructions from a non-transitory machine-readable medium and execute those instructions in a processor to perform the machine processing tasks discussed herein, such as the operations discussed above for the servers 102, the storage devices 104, the TAP patch panel 108, the monitoring system 110, and the information system 112. Specifically, FIG. 5 shows a diagrammatic representation of a machine in the example form of a computer system 500 within which instructions 524 (e.g., software) for causing the machine to perform any one or more of the methodologies discussed herein may be executed. In alternative embodiments, the machine operates as a standalone device or may be connected (e.g., networked) to other machines, for instance via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a data store 516, a signal generation device 518 (e.g., a speaker), an audio input device 526 (e.g., a microphone) and a network interface device 520, which also are configured to communicate via the bus 508.

The data store 516 includes a non-transitory machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network (not shown) via network interface 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors as described above in connection with FIG. 5. Alternatively, hardware or software modules may be stored elsewhere within a computing system.

As referenced herein, a computer or computing system includes hardware elements used for the operations described here regardless of specific reference in FIG. 5 to such elements, including for example one or more processors, high speed memory, hard disk storage and backup, network interfaces and protocols, input devices for data entry, and output devices for display, printing, or other presentations of data. Numerous variations from the system architecture specified herein are possible. The components of such systems and their respective functionalities can be combined or redistributed.

### Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

It is appreciated that the particular embodiment depicted in the figures represents but one choice of implementation. Other choices would be clear and equally feasible to those of skill in the art.

While the disclosure herein has been particularly shown and described with reference to a specific embodiment and various alternate embodiments, it will be understood by persons skilled in the relevant art that various changes in form and details can be made therein without departing from the spirit and scope of the disclosure.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience. This description should be read to include one or at least one and the singular also includes the plural unless it is obvious that it is meant otherwise.

Upon reading this disclosure, those of skill in the art will appreciate still additional alternative structural and functional designs for identifying slow draining devices through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
identifying a link in a storage area network affected by one or more slow draining devices;
identifying metric data for each of a plurality of candidate devices in the storage area network, each of the plurality of candidate devices potentially being a slow draining device affecting the link;
determining, for each of the plurality of candidate devices, a correlation value indicative of a likelihood that the candidate device is a slow draining device affecting the link, the correlation value determined based on correlation between the metric data identified for the candidate device and metric data associated with the link; and
storing one or more of the determined correlation values.

2. The method of claim 1, wherein determining the correlation value for a candidate device from the plurality of candidate devices comprises:
applying a cross-correlation function to the metric data identified for the candidate device and the metric data associated with the link to produce a plurality of correlation values; and
selecting, from the plurality of correlation values, a highest calculated correlation value as the correlation value for the candidate device.

3. The method of claim 1, wherein the plurality of candidate devices include servers in the storage area network that are configured to make read and write requests to storage devices in the storage area network.

4. The method of claim 1, wherein the metric data identified for each of the plurality of candidate devices includes data transmission rates of the candidate device at different times.

5. The method of claim 1, wherein the metric data identified for each of the plurality of candidate devices includes metric data of the candidate device at times that correspond to the metric data associated with the link.

6. The method of claim 1, wherein the metric data associated with the link includes a plurality of values of a percentage of time a device connected to the link spent with zero buffer-to-buffer credits.

7. The method of claim 1, wherein the metric data associated with the link includes data of a slow draining event identified in a series of data points associated with the link, the slow draining event a signature indicative of one or more slow draining devices affecting the link.

8. The method of claim 1, wherein the link is identified based on identifying a slow draining event in a series of data points associated with the link, the slow draining event a signature indicative of one or more slow draining devices affecting the link, each data point in the series describing a percentage of time during a time period that the link spent with zero buffer-to-buffer credits.

9. The method of claim 8, wherein identifying the link comprises:
determining a weighted score for the slow draining event based on data points of the series included in the slow draining event;
determining an aggregated event score for the link based on the weighted score determined for the slow draining event, the aggregated event score indicative of a degree to which one or more slow draining devices are affecting the link; and
identifying the link based on the aggregated event score.

10. The method of claim 9, wherein identifying the link based on the aggregated event score comprises:
identifying the link responsive to the aggregated event score being above a threshold.

11. The method of claim 9, wherein identifying the link based on the event score comprises:
identifying the link responsive to the event score being greater than additional event scores determined for additional links in the storage area network.

12. A computer-implemented method comprising:
identifying a link in a network experiencing a slowdown in traffic along the link;
identifying metric data for each of a plurality of candidate devices in the network, each of the plurality of candidate devices potentially being a cause of the traffic slowdown along the link;
determining, for each of the plurality of candidate devices, a correlation value indicative of a likelihood that the device is a cause of the traffic slowdown along the link, the correlation value determined based on correlation between the metric data identified for the device and metric data associated with the link; and
storing one or more of the determined correlation values.

13. The method of claim 12, wherein the link is identified based on identifying a slow draining event in a series of data points associated with the link, the slow draining event a signature indicative of one or more slow draining devices affecting the link, each data point in the series describing a percentage of time during a time period that the link spent with zero buffer-to-buffer credits.

14. A computer program product stored on a non-transitory computer-readable storage medium having computer-executable instructions, the computer program product comprising:
a link module configured to identify a link in a storage area network affected by one or more slow draining devices; and
a correlation module configured to:
identify metric data for each of a plurality of candidate devices in the storage area network, each of the plurality of candidate devices potentially being a slow draining device affecting the link;
determining, for each of the plurality of candidate devices, a correlation value indicative of a likelihood that the candidate device is a slow draining device affecting the link, the correlation value determined based on correlation between the metric data identified for the candidate device and metric data associated with the link; and
store one or more of the determined correlation values.

15. The computer program product of claim 14, wherein the plurality of candidate devices include servers in the storage area network that are configured to make read and write requests to storage devices in the storage area network.

16. The computer program product of claim 14, wherein the metric data identified for each of the plurality of candidate devices includes data transmission rates of the candidate device at different times.

17. The computer program product of claim 14, wherein the metric data identified for each of the plurality of candidate devices includes metric data of the candidate device at times that correspond to the metric data associated with the link.

18. The computer program product of claim 14, wherein the metric data associated with the link includes a plurality of values of a percentage of time a device connected to the link spent with zero buffer-to-buffer credits.

19. The computer program product of claim 14, wherein the metric data associated with the link includes data of a slow draining event identified in a series of data points associated with the link, the slow draining event a signature indicative of one or more slow draining devices affecting the link.

20. The computer program product of claim 14, wherein the link is identified based on identifying a slow draining event in a series of data points associated with the link, the slow draining event a signature indicative of one or more slow draining devices affecting the link, each data point in the series describing a percentage of time during a time period that the link spent with zero buffer-to-buffer credits.
